(19) United States
(12) Patent Application Publication
(10) Pub. No.: US 2022/0013796 A1
(43) Pub. Date: Jan. 13, 2022

(54) FUEL CELL SYSTEM AND FUEL CELL SYSTEM FOR VEHICLE

(71) Applicant: HONDA MOTOR CO., LTD., Tokyo (JP)

(72) Inventors: Daishi Igarashi, Wako-shi (JP); Satoru Kawase, Tokyo (JP); Kentaro Miura, Tokyo (JP); Shinji Matsunaga, Wako-shi (JP)

(21) Appl. No.: 17/366,056

(22) Filed: Jul. 2, 2021

(30) Foreign Application Priority Data
Jul. 10, 2020 (JP) 2020-119301

(51) Int. Cl. H01M 8/04089; H01M 8/24

(52) U.S. Cl. CPC H01M 8/04089; H01M 2250/20; H01M 8/24

(57) ABSTRACT

A fuel cell system for a vehicle includes a plurality of unit fuel cell groups, which are connected, each of unit fuel cell groups including a hydrogen tank, a fuel cell and a fuel cell controller configured to control power generation of the fuel cell, a tank controller configured to control filling and discharge of hydrogen in the hydrogen tank of each of at least two of the unit fuel cell groups, each of the unit fuel cell groups includes a hydrogen supply line configured to bring hydrogen to the fuel cell, the hydrogen supply lines of the at least two unit fuel cell groups are linked with each other, and the tank controller stops supply of hydrogen into the fuel cell of a unit fuel cell group in which an abnormality has been detected.

### CROSS-REFERENCE TO RELATED APPLICATION

Priority is claimed on Japanese Patent Application No. 2020-119301, filed Jul. 10, 2020, the content of which is incorporated herein by reference.

### BACKGROUND OF THE INVENTION

### Field of the Invention

The present invention relates to a fuel cell system and a fuel cell system for a vehicle.

### Description of Related Art

Regarding a system including a fuel cell, for example, in the case of a vehicle, the vehicle includes a tank in which hydrogen is stored, and travels using the hydrogen in the tank as fuel. Hydrogen is filled into the tank at, for example, a hydrogen supply station. In addition, the hydrogen stored in the tank is supplied to the fuel cell through a supply pipeline. Such a technology is disclosed in, for example, Japanese Unexamined Patent Application, First Publication No. 2006-200564.

### SUMMARY OF THE INVENTION

When a fuel cell is diverted to a commercial vehicle or the like that travels a long distance, there is a need to mount a plurality of connected tanks on a vehicle. However, there has been a problem in which, when a plurality of connecting routes from a fuel cell known in the related art to a plurality of tanks are prepared, the number of parts of the entire system is increased and the cost is increased as a whole.

An aspect of the present invention is directed to providing a fuel cell system having a plurality of tanks capable of achieving reduction in cost in the fuel cell system.

(1) A fuel cell system according to an aspect of the present invention is a fuel cell system in which a plurality of unit fuel cell groups are connected, each of the unit fuel cell groups including a hydrogen tank, a fuel cell, and a fuel cell controller configured to control power generation of the fuel cell, the fuel cell system including: a tank controller configured to control filling and discharge of hydrogen in the hydrogen tank of each of at least two of the unit fuel cell groups, wherein each of the unit fuel cell groups comprises a tank-side hydrogen line having one end connected to the hydrogen tank, and a hydrogen filling line and a hydrogen supply line that are branched off from other end of the tank-side hydrogen line, the hydrogen filling line and the hydrogen supply line extending toward a hydrogen filling port and the fuel cell, respectively, the hydrogen supply line brings hydrogen to the fuel cell, the hydrogen supply lines of the at least two unit fuel cell groups are linked with each other, a check valve configured to prevent a reverse flow of hydrogen from the tank-side hydrogen line is provided in the hydrogen filling line, the hydrogen filling lines of the at least two unit fuel cell groups are linked with each other at upstream of the check valve, each of the unit fuel cell groups includes a pressure reducing valve, and the tank controller stops supply of hydrogen into the fuel cell of a unit fuel cell group in which an abnormality has been detected.

(2) In the aspect of the above-mentioned (1), hydrogen is supplied from the hydrogen tank of another unit fuel cell group to the fuel cell of the unit fuel cell group in which the abnormality has been detected.

(3) In a fuel cell system for a vehicle according to another aspect of the present invention, the fuel cell system of the aspect of the above-mentioned (1) or (2) is mounted in the vehicle.

According to the fuel cell system of the aspect of the above-mentioned (1), the fuel cell system of the embodiment is configured by connecting the plurality of unit fuel cell groups, each including the hydrogen tank, the fuel cell and the fuel cell controller. For this reason, the mounted fuel cell system can be configured by being divided into a plurality of small groups, and for example, the fuel cell system for a vehicle mounted on a large-scale commercial vehicle can be constructed by diverting components of a fuel cell system for a passenger car. Accordingly, according to the embodiment, reduction in cost of the fuel cell system for a vehicle having the plurality of hydrogen tanks can be achieved.

Further, according to the fuel cell system of the aspect of the above-mentioned (1), one tank controller generally monitors filling and discharge of hydrogen gas in the hydrogen tanks of the plurality of unit fuel cell groups. For this reason, storage and discharge of hydrogen in the plurality of hydrogen tanks can be uniformly performed by the tank controller.

According to the fuel cell system of the aspect of the above-mentioned (1), each of the plurality of unit fuel cell groups includes the fuel cell controller. For this reason, even when some of the plurality of unit fuel cell groups are inoperable, the other unit fuel cell groups can be continuously operated, and reliability of the fuel cell system can be secured by increasing redundancy.

According to the fuel cell systems of the aspect of the above-mentioned (1), the hydrogen supply lines of the two unit fuel cell groups are linked with each other. For this reason, when the pressure of the hydrogen of the one unit fuel cell group is decreased, the hydrogen can be supplied from the other unit fuel cell group. That is, it is possible to suppress uneven reduction in residual pressure of the hydrogen between the pluralities of unit fuel cell group.

According to the fuel cell system of the aspect of the above-mentioned (1), when abnormality in the hydrogen tank of the one unit fuel cell group is detected and supply of the hydrogen is stopped, the unit fuel cell groups can mutually supply the hydrogen between each other. Accordingly, the fuel cells of both of the unit fuel cell groups can be driven and driving of the motor of the vehicle can be maintained. Further, for example, when the fuel cell system is mounted on the vehicle and the vehicle is a refrigerator truck, cooling inside a loading platform can be maintained by using electric power generated by the fuel cell. Accordingly, reliability of the fuel cell system for a vehicle can be enhanced.

According to the fuel cell system of the aspect of the above-mentioned (1), the hydrogen filling lines of the plurality of unit fuel cell groups can be merged at upstream side of the check valve. For this reason, the hydrogen filling port can be shared by the plurality of hydrogen filling lines.

According to the fuel cell system of the aspect of the above-mentioned (1), each of the plurality of unit fuel cell groups includes the pressure reducing valve. For this reason, the hydrogen in each of the unit fuel cell groups can be depressurized, and the pressure reducing valve thereof can be reduced in size. As a result, in comparison with the case in which depressurization is performed by one large pressure reducing valve, the fuel cell system can be reduced in size and weight as a whole. Further, for example, when the fuel cell system is mounted on the vehicle, since parts of the fuel cell system of the ordinary motor vehicle can be diverted, reduction in cost can be achieved.

According to the fuel cell system of the aspect of the above-mentioned (1), it is possible to prevent hydrogen from passing through the hydrogen supply line in which the abnormality has been detected and protect the hydrogen supply line.

According to the fuel cell system of the aspect of the above-mentioned (2), hydrogen can be supplied to the fuel cell of the unit fuel cell group in which the abnormality has been detected from the hydrogen tank of a unit fuel cell group in which no abnormality has been detected. For this reason, it is possible to drive the fuel cell of the unit fuel cell group in which the abnormality has been detected.

According to the fuel cell system for a vehicle of the aspect of the above-mentioned (3), it is possible to drive the vehicle using the above-mentioned fuel cell system.

### BRIEF DESCRIPTION OF THE DRAWINGS

FIG. 1 is a view showing components of a vehicle on which a fuel cell system is mounted.

FIG. 2 is a configuration view of the fuel cell system.

### DETAILED DESCRIPTION OF THE INVENTION

Hereinafter, a fuel cell system 100 for a vehicle of an embodiment of the present invention that is mounted on a vehicle will be described with reference to the accompanying drawings. Further, the drawings used in the following description may be shown with featured parts enlarged for the purpose of emphasizing the featured parts, and dimensional ratios of components may not be the same as the actual ones. In addition, for the same purpose, illustration of non-feature parts may be omitted.

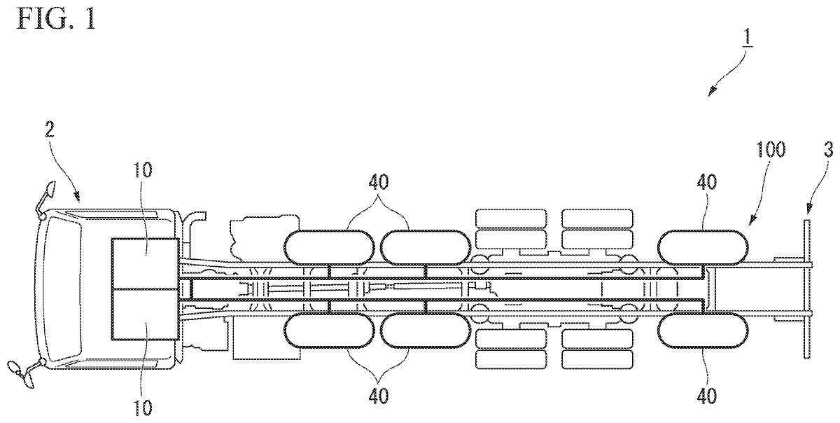

FIG. 1 is a view showing components of a vehicle 1 on which the fuel cell system 100 for a vehicle of the embodiment is mounted. The vehicle 1 on which the fuel cell system 100 for a vehicle is mounted is a fuel cell vehicle (FCV: a fuel cell automobile). The vehicle 1 of the embodiment is, for example, a commercial vehicle such as a large-sized vehicle, a mid-sized vehicle, or the like. In addition, the vehicle 1 may be a refrigerator truck or a freezer truck that cools a luggage compartment using electric power supplied from the fuel cell system 100 for a vehicle.

As shown in FIG. 1, the vehicle 1 has a cab 2 in which a driver's seat is disposed, a frame 3 equipped with a luggage compartment and towed by the cab 2, and the fuel cell system 100 for a vehicle. A fuel cell 10 of the fuel cell system 100 for a vehicle and a motor (not shown) configured to drive the vehicle 1 are mounted in the cab 2. The fuel cell 10 supplies electric power to the motor. In addition, a plurality of (in the embodiment, six) hydrogen tanks 40 of the fuel cell system 100 for a vehicle are fixed to the frame 3. The hydrogen tanks 40 supply hydrogen to the fuel cell 10.

Further, a state of the hydrogen in the fuel cell system 100 for a vehicle of the embodiment is all gas. Accordingly, even when “hydrogen” is simply written in the specification, it means “hydrogen gas.”

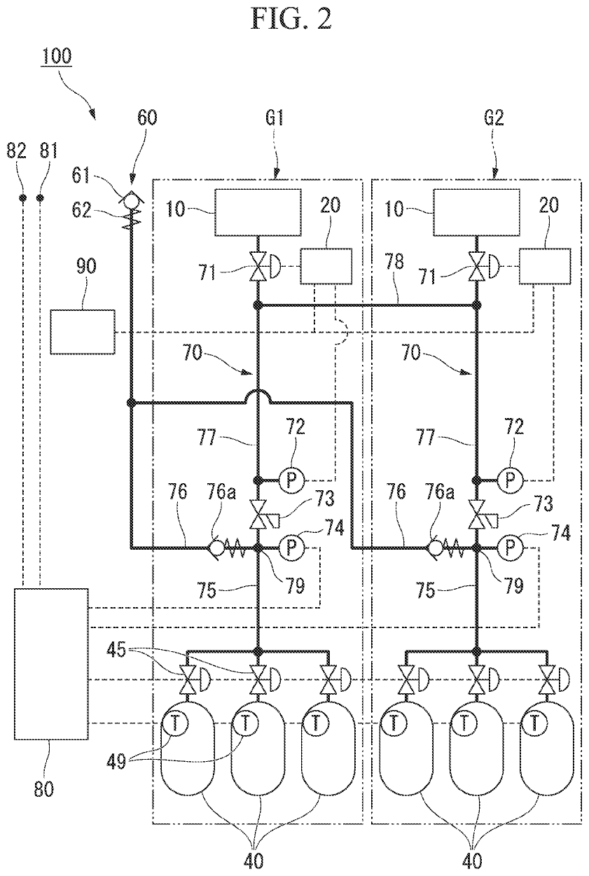

FIG. 2 is a configuration view of the fuel cell system 100 for a vehicle.

The fuel cell system 100 for a vehicle of the embodiment has two unit fuel cell groups G1 and G2 connected to each other, a fuel cell general controller 90, a tank controller 80, and a filling part 60.

The filling part 60 has a hydrogen filling port 61 to which a filling nozzle of an external hydrogen supply station is mounted. A filling port check valve 62 is provided in the hydrogen filling port 61. The filling port check valve 62 suppresses a reverse flow from hydrogen filling lines 76 of the unit fuel cell groups G1 and G2. In addition, the hydrogen filling port 61 is accommodated in an accommodating part closed by a lid.

Each of the unit fuel cell groups G1 and G2 includes the fuel cell 10, a fuel cell controller 20 configured to control the fuel cell 10, the hydrogen tanks 40, and a supply pipeline 70 configured to connect the fuel cell 10 and the hydrogen tanks 40.

Further, in the following description, when the two unit fuel cell groups G1 and G2 are discriminated, one of them is referred to as the first unit fuel cell group G1 and the other is referred to as the second unit fuel cell group G2.

The fuel cell 10 generates power using hydrogen as fuel, and supplies electric power to the motor (not shown) that drives the vehicle 1. The hydrogen is supplied to the fuel cell 10 from the hydrogen tanks 40 via the supply pipeline 70.

For example, the fuel cell 10 is configured as a fuel cell stack obtained by stacking a plurality of cells formed by having solid polymer electrolyte membranes, which are formed of solid polymer ion exchange membranes or the like, interposed between anodes and cathodes. Hydrogen serving as fuel is supplied to the side of the anodes of the fuel cell 10. In addition, air serving as an oxidizer is supplied to the side of the cathodes of the fuel cell 10. Hydrogen ions generated at the anodes due to catalytic reactions travel to the cathodes through the solid polymer electrolyte membranes and cause electrochemical reactions with oxygen on the cathodes.

The fuel cell controller 20 controls power generation of the fuel cell 10. More specifically, the fuel cell controller 20 adjusts a supply amount of hydrogen toward the anodes of the fuel cell 10 and a supply amount of air toward the cathodes according to an electric power demand on the side at the vehicle 1.

One fuel cell controller 20 is provided on the fuel cell 10 of each of the unit fuel cell groups G1 and G2. A power generation amount in the plurality of fuel cells 10 is managed in the fuel cell general controller 90. In addition, the fuel cell controllers 20 of the different unit fuel cell groups G1 and G2 and the fuel cell general controller 90 that organizes them are connected to each other by a multiplex communication line such as a controller area network (CAN) communication line or the like, a serial communication line, a wireless communication network, or the like. The fuel cell general controller 90 organizes the fuel cell controllers 20 of the two unit fuel cell groups G1 and G2.

The hydrogen tanks 40 store hydrogen (a high pressure gas) supplied from a hydrogen supply station via the filling part 60 at a high pressure. The hydrogen tanks 40 have, for example, cylindrical cylinder shapes in which both ends are hemi-spherically formed.

In the embodiment, three hydrogen tanks 40 are provided in each of the unit fuel cell groups G1 and G2. The supply pipeline 70 connected to the three the hydrogen tanks 40 in each of the unit fuel cell groups G1 and G2 are linked with each other.

A shut-off valve 45 and a temperature sensor 49 are provided in each of the hydrogen tanks 40. The shut-off valve 45 is connected to the tank controller 80. Opening and closing of the shut-off valve 45 are controlled by the tank controller 80. The shut-off valve 45 is open when the hydrogen tanks 40 are filled with hydrogen and the hydrogen filled in the hydrogen tanks 40 is supplied to the fuel cell 10.

The temperature sensor 49 is provided in each of the hydrogen tanks 40. The temperature sensor 49 measures a temperature of the hydrogen in the hydrogen tanks 40.

The tank controller 80 controls the filling and the discharge of each of the hydrogen tanks 40 (a total of six hydrogen tanks 40) of the unit fuel cell groups G1 and G2. The tank controller 80 is connected to the temperature sensor 49 of the hydrogen tank 40 and a first pressure sensor 74 in the supply pipeline 70. The tank controller 80 calculates a residual quantity of the hydrogen in the hydrogen tank 40 using a temperature in the hydrogen tank 40 measured by the temperature sensor 49 and a pressure measured by the first pressure sensor 74.

The tank controller 80 is connected to a display device 81. The tank controller 80 sends a signal to the display device 81 and displays a residual quantity of the hydrogen in the hydrogen tanks 40. In addition, the tank controller 80 may display an alarm on the display device 81 when a detection result of the temperature sensor 49 of the hydrogen tank 40 and a detection result of the first pressure sensor 74 exceed a predetermined threshold.

The tank controller 80 is connected to a filling port lid opening sensor 82. The filling port lid opening sensor 82 detects opening of the lid of the accommodating part in which the hydrogen filling port 61 is disposed. The tank controller 80 is shifted to a hydrogen filling mode when the hydrogen filling port 61 is open, and opens the shut-off valve 45 of the hydrogen tank 40 to accept filling of the hydrogen into the hydrogen tank 40.

The supply pipeline 70 has a tank-side hydrogen line 75, the hydrogen filling lines 76, and a hydrogen supply line 77. The tank-side hydrogen line 75, the hydrogen filling lines 76 and the hydrogen supply line 77 are linked at an intersecting part 79.

The first pressure sensor 74 is connected to the intersecting part 79. The first pressure sensor 74 may be provided in a route of the tank-side hydrogen line 75. The first pressure sensor 74 measures a pressure in the tank-side hydrogen line 75. A pressure measured by the first pressure sensor 74 when the shut-off valve 45 is open is considered as the pressure in the hydrogen tank 40.

The tank-side hydrogen line 75 has one end linked to the hydrogen tank 40 and the other end linked to the intersecting part 79. The tank-side hydrogen line 75 is branched off into three on the side of the hydrogen tanks 40 to be linked to each of the three hydrogen tanks 40.

The hydrogen filling lines 76 and the hydrogen supply line 77 are branched off from the other end (i.e., the intersecting part 79) of the tank-side hydrogen line 75 and extends toward the hydrogen filling port 61 and the fuel cell 10, respectively.

The hydrogen filling lines 76 connect the intersecting part 79 and the hydrogen filling port 61. Check valves 76a are provided in the hydrogen filling lines 76. The check valve 76a of the embodiment is located at connecting end portions of the hydrogen filling lines 76 closer to the side of the intersecting part 79. The check valve 76a prevents a reverse flow of the hydrogen from the tank-side hydrogen line 75. In addition, the hydrogen filling lines 76 of the two unit fuel cell groups G1 and G2 are linked to each other at upstream side of the check valve 76a (i.e., the side closer to the hydrogen filling port 61). The filling part 60 is provided at the end portions of the hydrogen filling lines 76 which is at upstream side of the linked hydrogen filling lines 76. The hydrogen filled from the filling part 60 is branched off to flow to the hydrogen filling lines 76 of the two unit fuel cell groups G1 and G2, and simultaneously supplied to the respective hydrogen tanks 40.

The hydrogen supply line 77 connects the intersecting part 79 and the fuel cell 10. The hydrogen supply line 77 brings the hydrogen in the hydrogen tanks 40 to the fuel cell 10. A pressure reducing valve 73, a second pressure sensor 72 and a control valve 71 are provided in the hydrogen supply line 77. The pressure reducing valve 73, the second pressure sensor 72 and the control valve 71 are arranged from the intersecting part 79 toward the fuel cell 10 in sequence.

The pressure reducing valve 73 depressurizes the high pressure hydrogen discharged from the hydrogen tanks 40 and distributes the hydrogen to the downstream side (i.e., the side of the fuel cell 10). The second pressure sensor 72 measures a pressure of the hydrogen depressurized by the pressure reducing valve 73. The second pressure sensor 72 is connected to the fuel cell controller 20. The control valve 71 is an injector controlled by the fuel cell controller 20. The fuel cell controller 20 controls the control valve 71 based on the pressure of the hydrogen in the hydrogen supply line 77 measured by the second pressure sensor 72 and adjusts a supply amount of the hydrogen into the fuel cell 10.

The hydrogen supply lines 77 of the two unit fuel cell groups G1 and G2 are linked with each other by a linking line 78. A linking section of the linking line 78 is disposed between the control valve 71 and the pressure reducing valve 73 of the hydrogens supply line 77. When the pressure in one of the hydrogen lines 75 of the two unit fuel cell groups G1 and G2 is decreased, the hydrogen on the other side is supplied toward the one side through the linking line 78.

### Actions and Effects

Next, actions and effects of the fuel cell system 100 for a vehicle will be described.

The fuel cell system 100 for a vehicle of the embodiment is constituted by linking the plurality of unit fuel cell groups G1 and G2 each including the hydrogen tanks 40, the fuel cell 10 and the fuel cell controller 20. For this reason, the fuel cell system mounted on the vehicle 1 can be constituted by being divided into a plurality of small groups, and the fuel cell system 100 for a vehicle mounted on a large-sized commercial vehicle can be constructed by diverting components of a fuel cell system for a passenger car. Accordingly, according to the embodiment, it is possible to achieve reduction in cost of the fuel cell system 100 for a vehicle having the plurality of hydrogen tanks 40.

According to the embodiment, the one tank controller 80 generally monitors the filling and the discharge of the hydrogen tanks 40 of the plurality of unit fuel cell groups G1 and G2. For this reason, storage and discharge of the hydrogen in the plurality of hydrogen tanks 40 can be uniformly performed by a tank controller 30.

According to the embodiment, each of the plurality of unit fuel cell groups G1 and G2 includes the fuel cell controller 20. For this reason, even when one of the plurality of unit fuel cell groups G1 and G2 is inoperable, the other unit fuel cell group can be continuously operated, and reliability of the fuel cell system 100 for a vehicle can be secured by increasing redundancy.

According to the embodiment, the hydrogen supply lines 77 of the two unit fuel cell groups G1 and G2 are connected to each other by the linking line 78. For this reason, when the pressure of the hydrogen of the one unit fuel cell group (for example, the first unit fuel cell group G1) is decreased, the hydrogen can be supplied from the other unit fuel cell group (for example, the second unit fuel cell group G2). That is, it is possible to suppress uneven reduction in residual pressure of the hydrogen between the plurality of unit fuel cell groups G1 and G2.

In addition, in the embodiment, for example, it is assumed that an abnormality is detected in the hydrogen supply line 77 of one of the unit fuel cell groups (for example, the first unit fuel cell group G1). In this case, the tank controller 80 closes the shut-off valve 45 of the hydrogen tank 40 of the first unit fuel cell group G1 to stop supply of the hydrogen. That is, the tank controller 80 stops supply of the hydrogen into the fuel cell 10 of the unit fuel cell group in which the abnormality was detected (for example, the first unit fuel cell group G1). Accordingly, it is possible prevent the hydrogen from passing through the hydrogen supply line 77 of the unit fuel cell group in which the abnormality was detected, and protect the hydrogen supply line 77. Meanwhile, in the second unit fuel cell group G2 in which no abnormality is detected, supply of the hydrogen from the hydrogen tanks 40 can be continued. That is, hydrogen is supplied from the hydrogen tanks 40 of the other unit fuel cell group (for example, the second unit fuel cell group G2) to the fuel cell 10 of the unit fuel cell group in which the abnormality has been detected (for example, the first unit fuel cell group G1). According to the embodiment, hydrogen can be supplied from the second unit fuel cell group G2 to the first unit fuel cell group G1 via the linking line 78. For this reason, the fuel cells 10 of the first and second unit fuel cell groups G1 and G2 can be driven together. Accordingly, driving of the motor of the vehicle 1 can be maintained. Further, when the vehicle 1 is a refrigerator truck, cooling inside a loading platform can be maintained using electric power generated by the fuel cell 10. As a result, reliability of the fuel cell system 100 for a vehicle can be increased.

According to the embodiment, the hydrogen filling lines 76 of the plurality of unit fuel cell groups G1 and G2 are merged at upstream side of the check valve 76a. For this reason, the hydrogen filling port 61 can be shared by the plurality of hydrogen filling lines 76. The hydrogen filled from the hydrogen filling port 61 is simultaneously supplied to the total of six hydrogen tanks 40 of the two unit fuel cell groups G1 and G2.

According to the embodiment, each of the plurality of unit fuel cell groups G1 and G2 includes the pressure reducing valve 73. For this reason, it is possible to depressurize the hydrogen in the hydrogen supply line 77 of each of the unit fuel cell groups G1 and G2 and minimize the pressure reducing valve 73 thereof. As a result, in comparison with the case in which depressurization is performed by the one large pressure reducing valve, the fuel cell system 100 for a vehicle can be reduced in size or weight as a whole. Further, since parts of a fuel cell system of an ordinary motor vehicle can be diverted, reduction in costs can be achieved.

Further, the technical scope of the present invention is not limited to the above-mentioned embodiment, and various modifications may be added to the above-mentioned embodiment without departing from the scope of the present invention. That is, the configuration or the like exemplified in the above-mentioned embodiment is only an example, and can be changed as appropriate. The vehicle is an example of a moving body, and a two-wheeled, three-wheeled or four-wheeled automobile. In addition, the vehicle may be a large-sized vehicle such as a bus, a truck, or the like, in which a plurality of fuel cell systems can be mounted. The fuel cell system may be mounted on a moving body other than the vehicle (for example, a ship, an aircraft, a robot), or may be mounted on a stationary fuel cell system.

For example, the case in which the fuel cell system 100 for a vehicle includes the two unit fuel cell groups G1 and G2 has been described in the above-mentioned embodiment. However, the fuel cell system 100 for a vehicle may include three or more unit fuel cell groups. Even in this case, the tank controller may control the filling and the discharge of the hydrogen tanks of the at least two unit fuel cell groups. In addition, the hydrogen supply lines 77 of the at least two unit fuel cell groups may be linked with each other. Further, the hydrogen filling lines of the at least two unit fuel cell groups may be linked with each other at upstream side of the check valve.

In addition, the case in which the linking line 78 is linked to the hydrogen supply line 77 between the control valve 71 and the pressure reducing valve 73 has been described in the embodiment. However, the linking line 78 may be linked to the hydrogen supply line 77 at upstream side of the pressure reducing valve 73 (on the side closer to the hydrogen tank 40).

In addition, while the case in which each of the unit fuel cell groups G1 and G2 has the three hydrogen tanks 40 has been described in the above-mentioned embodiment, the number of the hydrogen tanks 40 is not limited.

In addition, the case in which the shut-off valve 45 of the hydrogen tank 40 has functions of both of the filling valve and the supply valve has been described in the above-mentioned embodiment. However, the filling valve and the supply valve may be provided in each of the hydrogen tanks 40.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A fuel cell system in which a plurality of unit fuel cell groups are connected, each of the unit fuel cell groups comprising a hydrogen tank, a fuel cell, and a fuel cell controller configured to control power generation of the fuel cell, the fuel cell system comprising:
a tank controller configured to control filling and discharge of hydrogen in the hydrogen tank of each of at least two of the unit fuel cell groups,
wherein each of the unit fuel cell groups comprises a tank-side hydrogen line having one end connected to the hydrogen tank, and a hydrogen filling line and a hydrogen supply line that are branched off from other end of the tank-side hydrogen line, the hydrogen filling line and the hydrogen supply line extending toward a hydrogen filling port and the fuel cell, respectively,
the hydrogen supply line brings hydrogen to the fuel cell,
the hydrogen supply lines of the at least two unit fuel cell groups are linked with each other,
a check valve configured to prevent a reverse flow of hydrogen from the tank-side hydrogen line is provided in the hydrogen filling line,
the hydrogen filling lines of the at least two unit fuel cell groups are linked with each other at upstream of the check valve,
each of the unit fuel cell groups comprises a pressure reducing valve, and
the tank controller stops supply of hydrogen into the fuel cell of a unit fuel cell group in which an abnormality has been detected.

2. The fuel cell system according to claim 1, wherein hydrogen is supplied from the hydrogen tank of the other unit fuel cell group to the fuel cell of the unit fuel cell group in which the abnormality has been detected.

3. A fuel cell system for a vehicle in which the fuel cell system according to claim 1 is mounted in the vehicle.
